(19) United States
(12) Patent Application Publication
(10) Pub. No.: US 2010/0070360 A1
(43) Pub. Date: Mar. 18, 2010

(54) SYSTEM AND METHOD FOR CREATING A SPEECH SEARCH PLATFORM FOR COUPONS

(75) Inventors: Mazin GILBERT, Warren, NJ (US); Jay Wilpon, Warren, NJ (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT&T Intellectual Property I, L.P., Reno, NV (US)

(21) Appl. No.: 12/339,981

(22) Filed: Dec. 19, 2008

Related U.S. Application Data
(60) Provisional application No. 61/096,785, filed on Sep. 13, 2008.

(51) Int. Cl. G06Q 30/00; G06F 17/30; G06F 17/40; G06F 7/08

(52) U.S. Cl. 705/14.19; 707/E17.002; 707/E17.005; 707/E17.018; 707/E17.102

(57) ABSTRACT

Disclosed herein are systems, methods, and computer readable-media for creating a speech search platform for coupons. The method includes receiving coupons from vendors, generating indexing information about the received coupons for use with speech searches, integrating the received coupons and respective indexing information into a database accessible through a Representational State Transfer (REST) Application Programming Interface (API) as part of a speech search platform for coupons, receiving from a user a natural language query through the speech search platform for coupons, identifying coupons in the database which match the natural language query based on location and a user profile, and transmitting the identified coupons to the user. The method can further include modifying the REST API to include coupon-specific parameters. Identified coupons can be transmitted to the consumer by notifying a coupon issuer that the user is entitled to a discount.

### PRIORITY CLAIM

The present application claims the benefit of U.S. Provisional Application No. 61/096,785, filed Sep. 13, 2008 and relates to Non-Provisional Application No. 12/128,345, filed May 28, 2008 (Docket No. 2007-1412). The contents of these applications are incorporated herein by reference in their entirety.

### BACKGROUND OF THE INVENTION

1. Field of the Invention

The present invention relates to coupons and more specifically to allowing users to search a coupon database using a natural language query.

2. Introduction

A coupon is a piece of paper or other object which is exchanged for a financial discount or rebate when purchasing an item. Vendors often offer coupons as incentives to attract potential customers or advertise sales promotions. Some typical coupon distribution methods are newspapers, direct-mail, magazines, flyers, yellow pages phone directories, etc. Consumers receive or have access to hundreds or thousands of coupons, but may not remember where the coupons are, which ones are unexpired, or which ones are for products they want to purchase. The current print distribution methods of coupons are inefficient for quick indexing or searching.

Online coupons are rising in popularity with the help of deal-hunting websites but still require advance planning and significant effort. Typically, a consumer researches a particular good or service on such a website, locates a suitable coupon which may be specific to particular retailer or may only be valid for a short period of time, prints the coupon, and presents the coupon to the retailer at purchase. One consequence of this drawn-out process is that many consumers find dealing with coupons more of a hassle than they are worth. When consumers feel this way, the marketing value of coupons is reduced.

Accordingly, what is needed in the art is an improved, easier way for users to find relevant coupons for desired items.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods, and tangible computer readable-media for creating a speech search platform for coupons. The method includes receiving coupons from vendors, generating indexing information about the received coupons for use with speech searches, integrating the received coupons and respective indexing information into a database accessible through a Representational State Transfer (REST) Application Programming Interface (API) as part of a speech search platform for coupons, receiving from a user a natural language query through the speech search platform for coupons, identifying coupons in the database which match the natural language query based on location and a user profile, and transmitting the identified coupons to the user. The method can further include modifying the REST API to include coupon-specific parameters. Identified coupons can be transmitted to the consumer by notifying a coupon issuer that the user is entitled to a discount. Coupons can be received in the context of a directory of business listings. The step of generating indexing information can include extracting critical information from the received coupons. Coupons can be personalized for the user before transmitting the identified coupons to the user.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example method embodiment;

FIG. 3A illustrates a REST API request;

FIG. 3B illustrates a REST API response;

FIG. 4 illustrates a speech search platform architecture;

FIG. 5 illustrates a mobile device interface for invoking a speech search; and

FIG. 6 illustrates a vendor interface to upload coupons.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

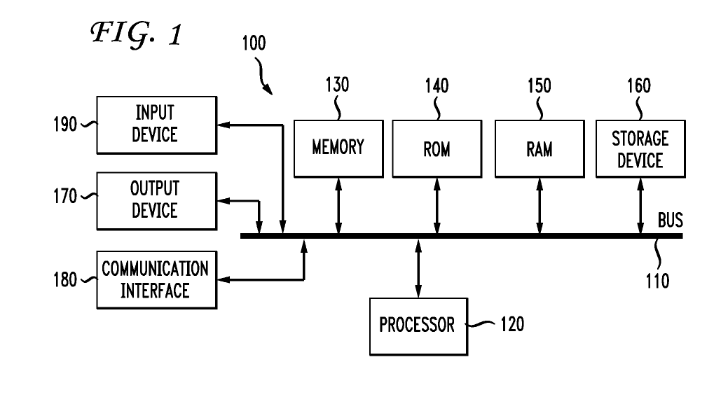

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. An Intel Xeon LV L7345 processor is an example of a general purpose CPU which is controlled by software. Particular functionality may also be built into the design of a separate computer chip. An STMicroelectronics STA013 processor is an example of a special-purpose processor which decodes MP3 audio files. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

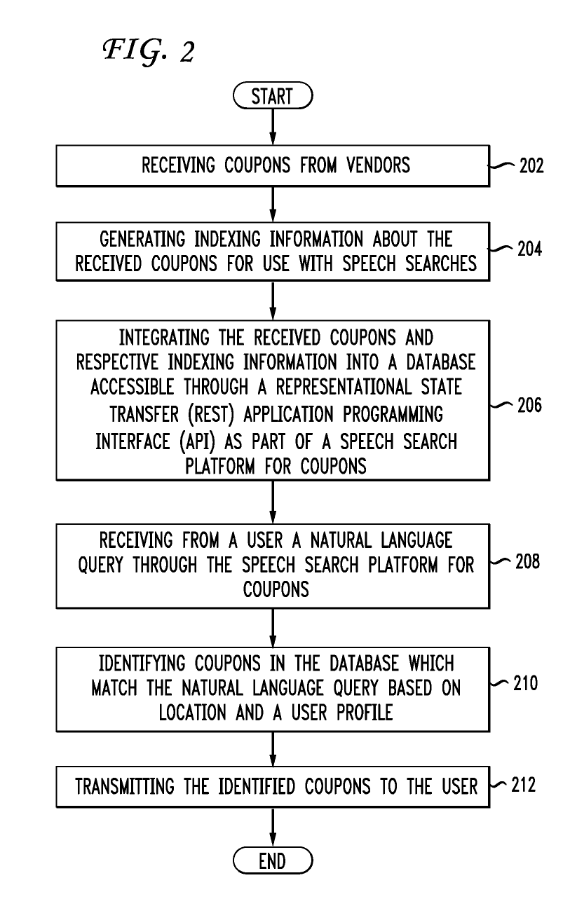

Having disclosed a basic system and some fundamental system components, the disclosure turns to the exemplary method embodiment. The method embodiment is discussed in terms of a system configured to practice the method. FIG. 2 illustrates an example method embodiment. The system receives coupons from vendors (202). The system can receive coupons in the context of a directory of business listings, such as Yellow Pages, a web-based business directory, a local community listing, or other directory. Traditional print Yellow Page directories include coupons, so the system can be used in conjunction with an online yellow page directory to provide coupons in a manner consistent with the print versions.

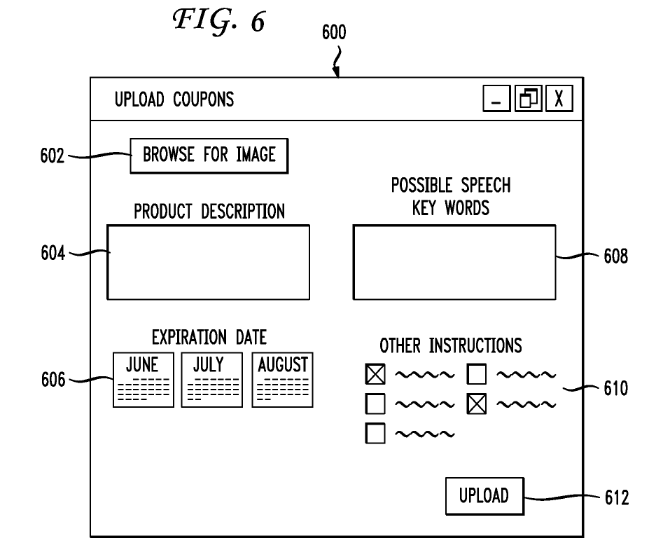

The system generates indexing information about the received coupons for use with speech searches (204). The system can generate indexing information by extracting critical information from the received coupons. Vendors can enter indexing information when uploading a coupon to the system. The system can extract information from received coupons such as images, product descriptions, discount amounts, expiration dates, possible key words, etc. Further information can be extracted by applying optical character recognition (OCR) to any associated images. FIG. 6 illustrates a sample interface for uploading coupons and additional information.

The system integrates the received coupons and respective indexing information into a database accessible through a Representational State Transfer (REST) Application Programming Interface (API) as part of a speech search platform for coupons (206). The system can further modify the REST API to include coupon-specific parameters. The speech platform is essentially a place to accept coupons from vendors and make them universally speech-searchable for consumers.

The system receives from a user a natural language query through the speech search platform for coupons (208) and identifies coupons in the database which match the natural language query based on location and a user profile (210). The natural language query can be spoken or written. The search speech can also serve another purpose. For example, in a speech-driven Yellow Pages search, a user speaks the query “I want to see all the home improvement stores in Springfield, Mont.”. The query is primarily directed to a Yellow Pages directory search, but the system can use the same query speech to find coupons. As the system processes the speech query for the directory search, the system also uses the speech query to locate appropriate coupons in a coupon database. The system can present both the search results and any relevant coupons together to the user.

The system transmits the identified coupons to the user (212). In one aspect, the system sends text and/or image-based coupons to the user via email, SMS, mail, or other messaging means. In another aspect, the system transmits coupons by notifying a coupon issuer that the user is entitled to a discount.

In one aspect, the system personalizes coupons for the user before transmission to the user. For example, if a user's history indicates that she responds well to 50% off coupons but not so well to coupons taking a specific dollar amount off (like $10 off a $50 purchase) the system can personalize the coupon to match the user's response history. In a simpler example, the system personalizes coupons to include the user's first name. The system can personalize a coupon by combining it with other known offers which may appeal to the user. In another aspect, the vendor provides several levels of the same coupon. For example, the vendor is willing to provide a coupon up to 25% off, but prefers less. The system can personalize the coupon based on expected user response, providing a 10% off coupon for one person, a 20% off coupon for another person, and a 25% off coupon for a third person.

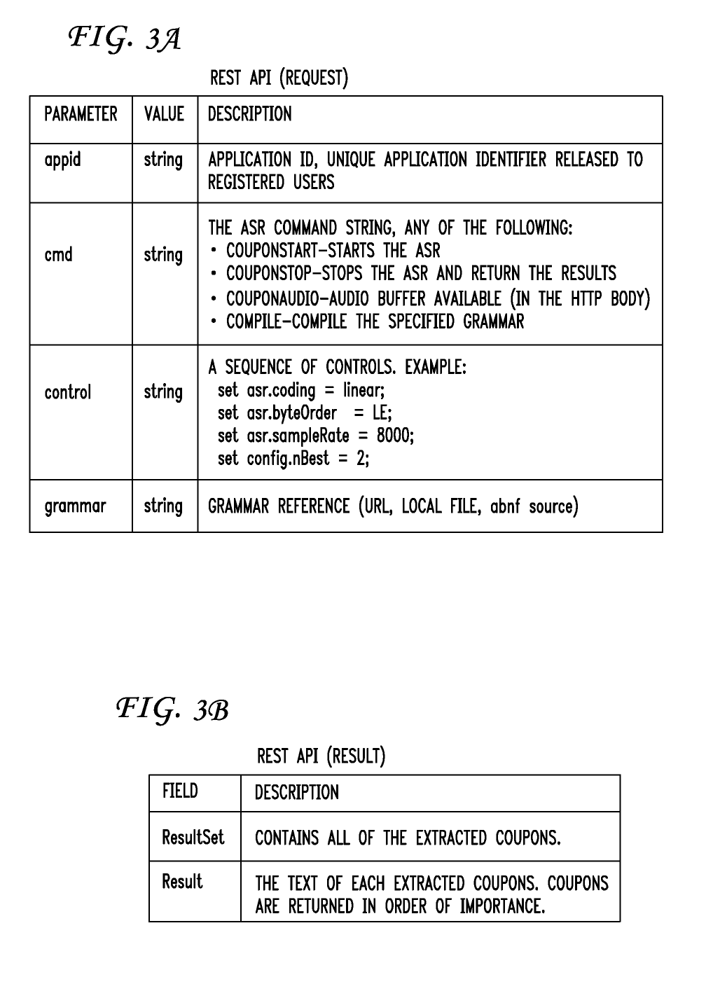

FIG. 3A illustrates a sample REST API example for a request. Included in this figure are the descriptions of various parameter subsets that provide example embodiments of how an API would enable the speech processing in a user interface. For example, under the CMD parameter, the description includes the concept that the ASR command string may provide a start indication to start automatic speech recognition and a stop indication to stop automatic speech recognition and return the results. There can be an audio buffer available and the opportunity to compile a specified grammar. Thus, these command strings may control use of the buffer or compilation or application of various grammars. Other control strings include data to control a byte order, coding, sampling rate, n-best results and so forth. If a particular control code is not included, default values are assumed. The REST API can also include other features such as a grammar to identify a particular grammar reference that can be associated with a user or a particular domain and so forth. The REST API includes a grammar parameter that will identify a particular grammar for use in the travel industry, the information industry, the searching industry, Yellow Pages directory assistance context and so forth. Furthermore, the REST API provides a parameter associated with a particular grammar for a user that is selected from a group of grammars such that the appropriate grammar may be used to provide the highest quality speech recognition for a particular user. Other REST APIs can also be location-based. For example, using a location based service, a particular mobile device may be found at a particular location, and the REST API may automatically insert a particular parameter that may be associated with a particular location. This may cause a modification or the selection of a particular grammar for use in the speech recognition

In an exemplary embodiment, the system combines the current location of a tourist, like Gettysburg, with the home location of the tourist, like Texas. The system selects an appropriate grammar based on what the system is likely to encounter when interfacing with individuals from Texas visiting Gettysburg. The system selects a grammar to anticipate either a Texas southern drawl accent or a Hispanic accent. The system selects a grammar to anticipate a likely vocabulary for tourists at Gettysburg, taking in to account prominent attractions, commonly asked questions, or other words or phrases. The system can automatically select a grammar based on available information, the system can present its best guess for a grammar to the user for confirmation, or the system can offer a list of grammars to the user for a selection of the most appropriate.

FIG. 3B illustrates an example REST API response that includes a field ResultSet that contains all of the extracted coupons and a Result field that is described as the text of each extracted coupons and in which coupons are returned in the order of importance.

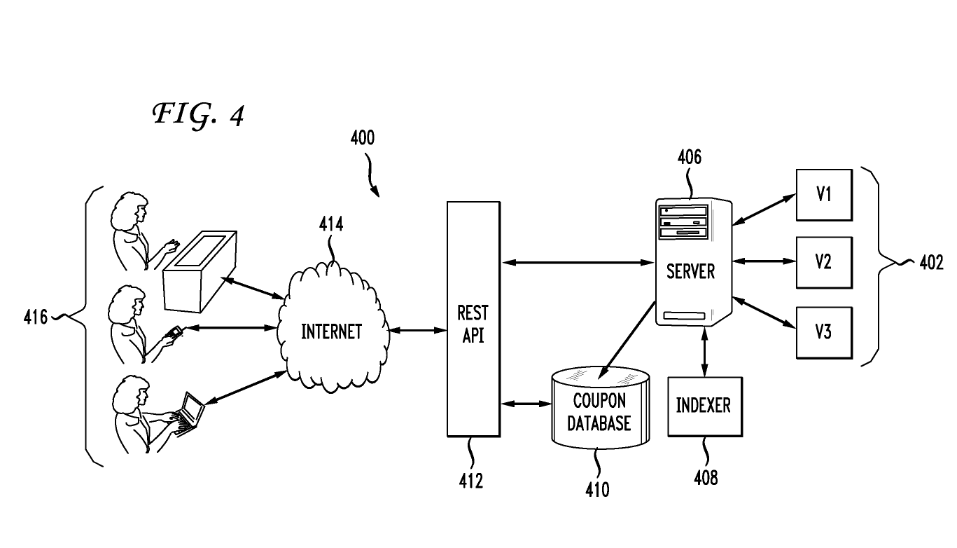

FIG. 4 illustrates a speech search platform architecture 400. In this architecture, vendors V1, V2, and V3 402 upload coupons to a server 406. The server passes uploaded coupons to an indexer 408 which parses the coupons to extract usable indexing information. In addition to an indexer 408, vendors 402 can generate and upload information about the coupons. The server then stores coupons and indexing information in a coupon database 410. Vendors can change and remove previously uploaded coupons in the coupon database 410 through the server 406. Users 416 enter speech queries through multiple computing devices, such as desktop computers, laptop computers, kiosks, mobile devices, smartphones, etc. Nearly any network-enabled computing device with a microphone is suited for accepting speech queries. The system accepts queries from users 416 over a network 414 such as the Internet or a telephone network. The system can accept speech queries in many forms such as audio streams, data streams, uncompressed audio, compressed audio, etc. The REST API 412 sits between the users 416 on one side and the server 406 and coupon database 410 on the other side. The REST API can be established wholly or partially in a computing device 416, on the server 406, and/or in the network 414 to facilitate speech processing in the user interface of the various computing devices 416. The server 406 responds to speech queries by retrieving coupons from the database which match the natural language query based on location and a user profile. The server then transmits the retrieved coupons to the respective user's computing device 416 through the network 414. The users can print out coupons or store them in the computing device as an image of a barcode for use with a vendor's barcode scanner.

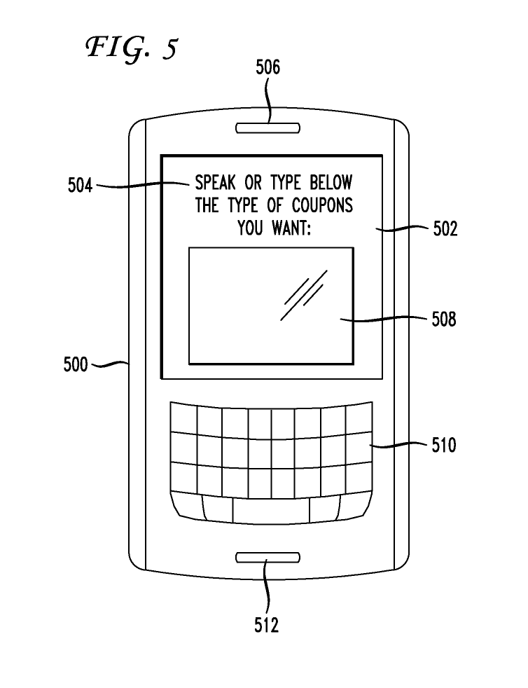

FIG. 5 illustrates a mobile device interface for invoking a speech search. The natural language coupon search can be its own application or it can be included as a feature or part of another software application. The interface shown can be part of a yellow pages directory application on a mobile device 500, for example. The screen 502 of the mobile device can display a visual prompt 504 to the user to enter a query or a speaker 506 can issue an audible prompt. As the user speaks or enters a response, a textbox 508 can show the recognized words. The user can enter a query in natural language by typing it on a keypad or keyboard 510 or by saying the query aloud in natural language into a microphone 512. The mobile device can then transmit the speech query to a remote server via a network connection as shown in FIG. 4. The system can update the screen 502 with a listing of coupons and options for the user to save, print, email, or otherwise obtain a desired coupon.

FIG. 6 illustrates a vendor interface to upload coupons. The vendor interface 600 can be a web page, a standalone software application, or other similar interface. The system controlling the interface can implement some kind of security or authentication system to ensure that only authorized vendors can upload coupons. A vendor can upload an image 602 of a coupon for printing or displaying on a screen in one of many formats such as BMP, JPG, TIFF, GIF, PNG, PDF, etc. The vendor can enter a product description 604, a coupon description, or other descriptive text in plain text format or an enhanced text format such as RTF or Microsoft Word® format. The vendor can specify an expiration date 606 for the coupon. The vendor can also specify a starting date for the coupon if it is supposed to go into effect at a future date rather than immediately. Vendors can attempt to target the coupon to some degree by explicitly designating possible speech key words 608 for use with this coupon. For example, typical indexing methods may miss an important key word associated with the coupon. In these cases, a vendor can provide additional key words to boost their coupon's chances for distribution. The vendor can also include other instructions 610 not explicitly listed above. The other instructions can be in the form of a checklist of options, a pulldown menu, or other selection-related user interface widget. Some examples of what other instructions are anticipated are region, intended demographic information, and a maximum number of copies of the coupon to reproduce. The system does not require that vendors enter all this additional information. Vendors can enter as little or as much indexing information regarding their coupons as they wish. When the vendor is satisfied with the entered information, the vendor can click an upload button 612 to send the entered indexing information to the server for inclusion in the coupon database.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles herein may be applied to . . . . Those skilled in the art will readily recognize various modifications and changes that may be made to the present invention without following the example embodiments and applications illustrated and described herein, and without departing from the true spirit and scope of the present invention.

We claim:

1. A method of creating a speech search platform for coupons, the method comprising:
receiving coupons from vendors;
generating indexing information about the received coupons for use with speech searches;
integrating the received coupons and respective indexing information into a database accessible through a Representational State Transfer (REST) Application Programming Interface (API) as part of a speech search platform for coupons;
receiving from a user a natural language query through the speech search platform for coupons;
identifying coupons in the database which match the natural language query based on location and a user profile; and
transmitting the identified coupons to the user.

2. The method of claim 1, the method further comprising modifying the REST API to include coupon-specific parameters.

3. The method of claim 1, wherein the identified coupons are transmitted to the consumer by notifying a coupon issuer that the user is entitled to a discount.

4. The method of claim 1, wherein coupons are received in the context of a directory of business listings.

5. The method of claim 1, wherein generating indexing information includes extracting critical information from the received coupons.

6. The method of claim 1, the method further comprising personalizing identified coupons for the user before transmitting the identified coupons to the user.

7. A system for creating a speech search platform for coupons, the system comprising:
a module configured to receive coupons from vendors;
a module configured to generate indexing information about the received coupons for use with speech searches;
a module configured to integrate the received coupons and respective indexing information into a database accessible through a Representational State Transfer (REST) Application Programming Interface (API) as part of a speech search platform for coupons;
a module configured to receive from a user a natural language query through the speech search platform for coupons;
a module configured to identify coupons in the database which match the natural language query based on location and a user profile; and
a module configured to transmit the identified coupons to the user.

8. The system of claim 7, the system further comprising modifying the REST API to include coupon-specific parameters.

9. The system of claim 7, wherein the identified coupons are transmitted to the consumer by notifying a coupon issuer that the user is entitled to a discount.

10. The system of claim 7, wherein coupons are received in the context of a directory of business listings.

11. The system of claim 7, wherein generating indexing information includes extracting critical information from the received coupons.

12. The system of claim 7, the system further comprising a module configured to personalize identified coupons for the user before transmitting the identified coupons to the user.

13. A tangible computer-readable medium storing a computer program having instructions for creating a speech search platform for coupons, the instructions comprising:
receiving coupons from vendors;
generating indexing information about the received coupons for use with speech searches;
integrating the received coupons and respective indexing information into a database accessible through a Representational State Transfer (REST) Application Programming Interface (API) as part of a speech search platform for coupons;
receiving from a user a natural language query through the speech search platform for coupons;
identifying coupons in the database which match the natural language query based on location and a user profile; and
transmitting the identified coupons to the user.

14. The computer-readable medium of claim 13, the instructions further comprising modifying the REST API to include coupon-specific parameters.

15. The computer-readable medium of claim 13, wherein the identified coupons are transmitted to the consumer by notifying a coupon issuer that the user is entitled to a discount.

16. The computer-readable medium of claim 13, wherein coupons are received in the context of a directory of business listings.

17. The computer-readable medium of claim 13, wherein generating indexing information includes extracting critical information from the received coupons.

18. The computer-readable medium of claim 13, the instructions further comprising personalizing identified coupons for the user before transmitting the identified coupons to the user.
